(19) United States
(12) Patent Application Publication
(10) Pub. No.: US 2025/0173936 A1
(43) Pub. Date: May 29, 2025

(54) METHOD FOR NEURAL NETWORK DRIVEN VERTEX ANIMATION FOR LATENCY AND COMPATIBILITY OPTIMIZATION AND ARTIFICIAL INTELLIGENCE DEVICE AND SYSTEM THEREOF

(71) Applicant: LG ELECTRONICS INC., Seoul (KR)

(72) Inventors: Felix TAUBNER, Toronto (CA); Jinmiao HUANG, Toronto (CA); Prashant RAINA, Toronto (CA); Eu Wern TEH, Toronto (CA); Mathieu TULI, Toronto (CA)

(73) Assignee: LG ELECTRONICS INC., Seoul (KR)

(21) Appl. No.: 18/958,699

(22) Filed: Nov. 25, 2024

Related U.S. Application Data
(60) Provisional application No. 63/602,455, filed on Nov. 24, 2023.

(51) Int. Cl. G06T 13/20; G06T 15/50; G06T 17/20

(52) U.S. Cl. CPC G06T 13/205; G06T 15/503; G06T 17/20

(57) ABSTRACT

A method for neural network driven vertex animation can include receiving, by an encoder component of a trained neural network, an input driving signal including audio data, processing, by the encoder component, the input driving signal to generate blendshape coefficient information based on the input driving signal, transmitting, by the encoder component, the blendshape coefficient information to a decoder component of the trained neural network, receiving, by the decoder component, the blendshape coefficient information from the encoder component, and generating, by the decoder component, vertex position information based on the blendshape coefficient information for animating a 3D model.

### CROSS-REFERENCE TO RELATED APPLICATIONS

This non-provisional application claims priority under 35 U.S.C. § 119 (e) to U.S. Provisional Application No. 63/602,455, filed on Nov. 24, 2023, the entirety of which is hereby expressly incorporated by reference into the present application.

### BACKGROUND

### Field

The present disclosure relates to a device and method for neural network driven vertex animation, in the field of artificial intelligence (AI). Particularly, the method can use a neural network to animate facial expressions by predicting vertex positions and generating blendshapes while improving latency and compatibility.

### Discussion of the Related Art

Artificial intelligence (AI) continues to transform various aspects of society and helps users by powering advancements in various fields, particularly with regards to computer graphics, animation and interactive applications.

Creating realistic and expressive facial animation is a persistent challenge in computer graphics, which can be manually time consuming and expensive. Existing techniques typically involve either blendshape animation or direct vertex manipulation, each with inherent limitations.

Blendshape animation often relies on a predefined set of 3D shapes representing different facial expressions (e.g., smiling, surprised, angry, etc.). Blendshape animation may struggle to capture the full spectrum of human expression by limiting animators to a finite set of pre-sculpted emotions. Creating blendshapes is also a labor-intensive process which demands artistic skill and significant time investment. Also, storing a vast library of blendshapes can strain memory and storage resources, especially for high-resolution models.

Direct vertex manipulation allows animators to control the positions of individual vertices in a 3D mesh model. This can provide finer control over facial movements but comes with increased complexity. For example, adjusting individual vertices for each frame of animation can be a tedious and technically demanding task that requires specialized tools and expertise. The computational cost of calculating and updating numerous vertex positions in real-time can also lead to performance bottlenecks, particularly on devices with limited processing power and constrained bandwidth. Also, direct vertex manipulation often lacks standardization, hindering compatibility and interoperability between different animation systems.

In addition, blendshape animation and direct vertex manipulation both face challenges in efficiently delivering high-fidelity facial animation in real-time applications, especially when animation data needs to be streamed over a network, between devices, or between components on a same chip. Transmitting the complete 3D mesh data for each frame can result in significant latency and bandwidth consumption, which impairs the fluidity and responsiveness of the animation.

Accordingly, there exists a need for a method and system that can achieve realistic and expressive facial animation in interactive applications by leveraging neural networks to predict and generate facial movements with high fidelity and efficiency. For example, there exists a need for a solution that can automate the process of predicting vertex positions and generating blendshapes for animating facial expressions while preserving fine facial details, reducing the need for manual labor and artistic expertise.

Further, a need exists for a method and system that can enable efficient real-time animation, even on devices with limited processing power. Also, a need exists for a solution that can minimize data transfer and be seamlessly integrating with existing platforms, such as game engines. Accordingly, a need exists for a method that can combine automation, high fidelity, efficiency and compatibility for providing improved computer animation.

### SUMMARY OF THE DISCLOSURE

The present disclosure has been made in view of the above problems and it is an object of the present disclosure to provide a device and method that can provide a device and method for neural network driven vertex animation, in the field of artificial intelligence (AI). Further, the method can automatically generate animations by predicting vertex positions and generating blendshapes while improving latency and compatibility. Further, the method can minimize data transfer and be seamlessly integrating with existing platforms.

An object of the present disclosure is to provide a method for controlling an artificial intelligence (AI) device that uses a neural network with an encoder-decoder architecture to predict vertex positions and generate blendshape coefficients that can be transmitted to a target device where they are applied to a set of blendshapes to reconstruct the full animation, enabling efficient and realistic animation having in interactive applications, while also minimizing data transfer.

Another object of the present disclosure is to provide a method for neural network driven vertex animation that includes receiving, by an encoder component of a trained neural network, an input driving signal including audio data, processing, by the encoder component, the input driving signal to generate blendshape coefficient information based on the input driving signal, transmitting, by the encoder component, the blendshape coefficient information to a decoder component of the trained neural network, receiving, by the decoder component, the blendshape coefficient information from the encoder component, and generating, by the decoder component, vertex position information based on the blendshape coefficient information for animating a 3D model.

It is another object of the present disclosure to provide a method for controlling an artificial intelligence (AI) device that includes receiving, by an encoder component of a trained neural network, an input driving signal including audio data, processing, by the encoder component, the input driving signal to generate blend shape coefficient information based on the input driving signal; transmitting, by the encoder component, the blendshape coefficient information to a decoder component of the trained neural network, receiving, by the decoder component, the blendshape coefficient information from the encoder component, and generating, by the decoder component, vertex position information based on the blendshape coefficient information for animating a 3D model.

Another object of the present disclosure is to provide a method that includes displaying the 3D model with aminated movements based on the vertex position information.

An object of the present disclosure is to provide a method, in which the blendshape coefficient information includes an F×B matrix of blendshape coefficients, where F corresponds to a number of animation frames corresponding to an audio length of the input driving signal, and B corresponds to a number of blendshapes, and the vertex position information includes an F′×V×3 tensor, where F′ corresponds to a number of animation frames for animating the 3D model, V corresponds to a number of vertices in the 3D model, and 3 corresponds to x, y, and z coordinates of the vertices.

Another object of the present disclosure is to provide a method, in which the encoder component is located on a server, and the decoder component is located on an edge device that is separate from the server.

Yet another object of the present disclosure is to provide a method, in which the decoder component includes a fully connected layer.

Another object of the present disclosure is to provide a method, in which the fully connected layer is represented as WX+b, where W is a weight matrix, b is a bias vector or a base mesh, and X is the blendshape coefficient information output from the encoder.

Another object of the present disclosure is to provide a method that includes transforming information based on the decoder into a set of blendshapes based on converting the weight matrix into distinct blendshapes, in which each blendshape in the set of blendshapes includes a matrix corresponding to a single blendshape defining positions of vertices for a specific expression or animation.

An object of the present disclosure is to provide a method that includes generating the trained neural network by inputting pairs of input data and ground-truth tensors including vertex position information to a neural network, outputting predicted tensors by the neural network, and optimizing the neural network to minimize a loss function based on a difference between the predicted tensors and ground-truth tensors for producing the trained neural network.

Another object of the present disclosure is to provide a method for controlling an artificial intelligence (AI) device that includes receiving an input driving signal including audio data, processing the input driving signal by an encoder component of a trained neural network to generate blendshape coefficient information based on the input driving signal, and transmitting the blendshape coefficient information over a network to a target device for animating a 3D model.

An object of the present disclosure is to provide an artificial intelligence (AI) system that can include an encoder component of a trained neural network configured to receive an input driving signal including audio data, process the input driving signal to generate blendshape coefficient information based on the input driving signal, and transmit the blendshape coefficient information, and a decoder component of the trained neural network configured to receive the blendshape coefficient information from the encoder component, and generate vertex position information based on the blendshape coefficient information for animating a 3D model.

Another object of the present disclosure is to provide an artificial intelligence (AI) device including a display configured to display an image, a memory configured to store 3D model information, and a controller configured to receive blendshape coefficient information from an external device, generate vertex position information based on a trained neural network for animating a 3D model, and display the 3D model with aminated movements based on the vertex position information.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 shows examples of blendshapes and a mesh, according to embodiments of the present invention.

FIG. 5 illustrates an example flow chart for a method for neural network driven vertex animation according to an embodiment of the present invention.

FIG. 6 shows examples of network architecture during a training phase and an inference phase, according to embodiments of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

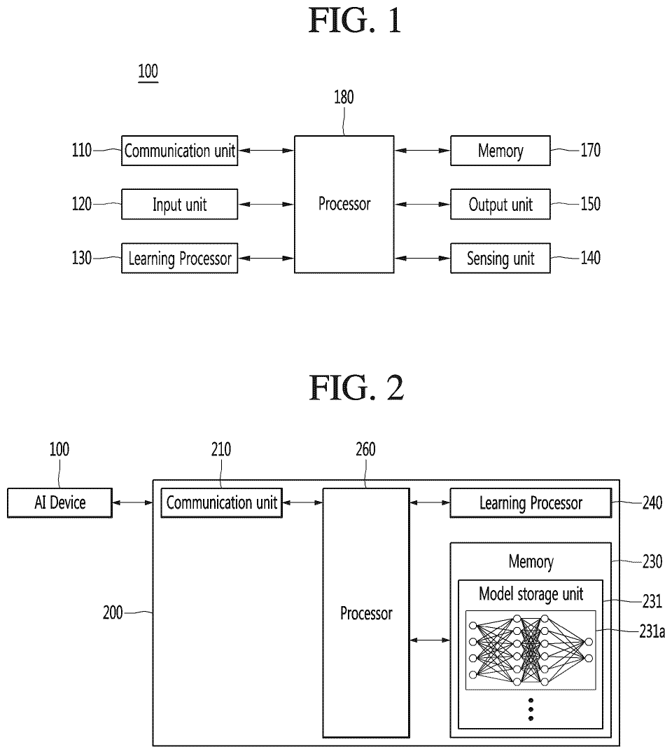

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

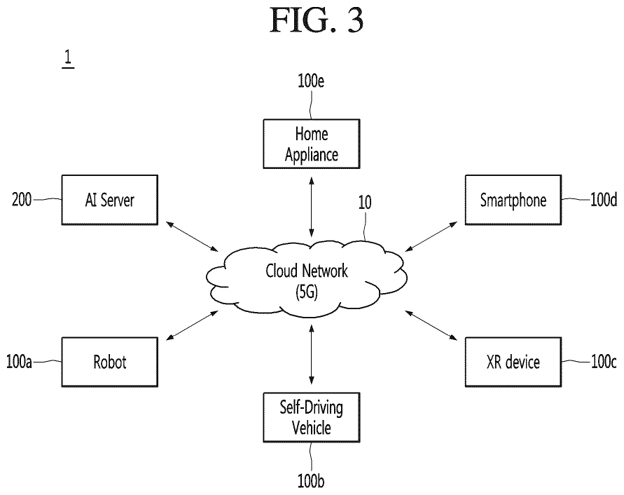

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement neural network driven vertex animation and can animate facial expressions by predicting vertex positions and generating blendshapes while improving latency and compatibility.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an answer, carry out an action or movement, animate a displayed avatar or a recommend an item or action based on the acquired information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the AI model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an evaluation method, a question and answering system or a recommendation system using an animated avatar. Also, the avatar can perform virtual product demonstrations and provide user tutorials and maintenance tutorials. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar with animated facial movements and expressions.

According to an embodiment, the AI device 100 can provide neural network driven vertex animation, and animate facial expressions by predicting vertex positions and generating blendshapes while improving latency and compatibility.

According to another embodiment, the AI device 100 can be integrated into an infotainment system of the self-driving vehicle 100b in the form of a digital avatar, which can recognize different users and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, achieving realistic and expressive facial animation in interactive applications can be difficult and expensive.

According to an embodiment, the AI device and method can improve computer animation. For example, the method can provide an improved approach that uses a neural network to animate facial expressions by predicting vertex positions and generating blendshapes while improving latency and compatibility.

Developers typically animate faces and models using either blendshapes (e.g., predefined facial expressions) or by directly manipulating mesh vertices (e.g., individual points that define the 3D model). Blendshapes can be efficient but can lack detail and require artistic skill and labor to create. Also, vertex manipulation can offer fine-grained control but is time-consuming and computationally expensive.

In more detail, blendshapes are a set of predefined 3D shapes or states that a 3D model can smoothly transition between. These shapes can be used to alter the geometry of a character's face or body. Each blendshape represents a specific deformation or pose of the mesh, such as smiling, frowning, blinking, or any other facial expression or shape change.

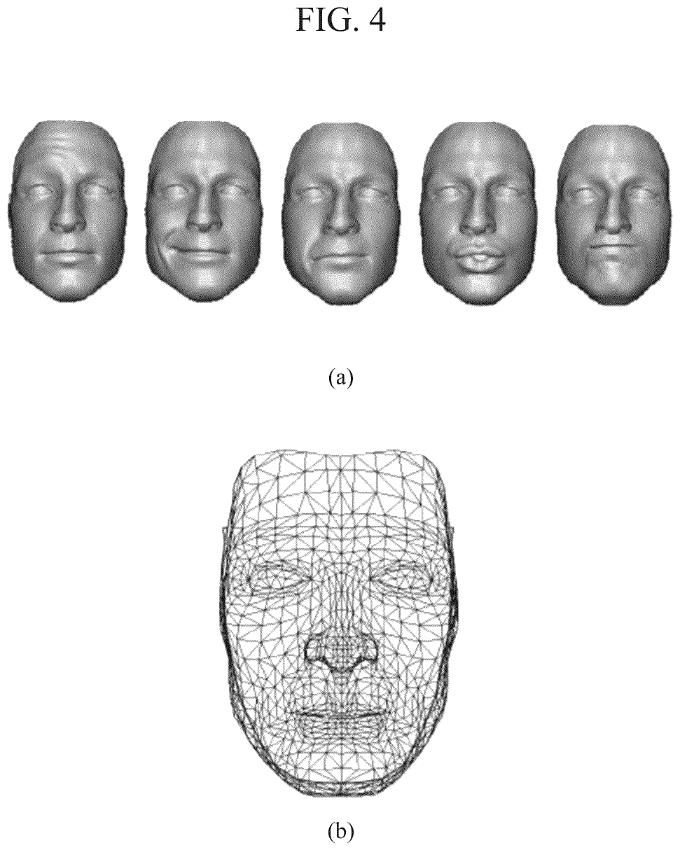

FIG. 4, part (a) shows an example of blendshapes that include a right eyebrow raise, a right lip corner smile, a right lip corn frown, a lip pucker and a chin raise. For example, blendshapes are primarily used for character animation. Instead of deforming the character's mesh using complex skeletal rigging and bone-based animations, blendshapes allow for precise control over the character's facial expressions and other deformations.

For example, a blendshape is a type of morph target used for a 3D model deformation technique where a set of predefined target shapes can be used to alter the geometry of a base mesh. Each blendshape can represent a specific expression or deformation, such as a smile, frown, or raised eyebrow, etc. By blending between these target shapes with varying weights, a wide range of facial expressions and body movements can be created. Blendshapes can be used for characters in video games, digital avatars and animated films.

Animators can create a range of expressions and deformations by blending between different shapes, hence the name “blendshapes.”

Blendshapes are computationally efficient and can be calculated and interpolated in real-time by a game engine, making them suitable for interactive applications like games. This efficiency can help maintain smooth animations at high frame rates and for a large number of vertices.

However, creating blendshapes can be a time-consuming and skill-intensive process, which poses significant challenges when attempting to swiftly generate custom avatars from scanned or photographed user head data. These hurdles can hinder the widespread application of this technology for personalized avatar generation or reconstruction. Also, per vertex control fidelity is limited to the number of blendshapes used.

FIG. 4, part (b) shows an example of a mesh which is a polygonal surface that describes the geometric surfaces of a face or other object. For example, a mesh refers to a 3D model or object that is represented as a collection of vertices, edges, and faces (e.g., polygons) to create a 3D shape or structure.

Meshes can be used to represent and render objects and characters in 3D environments. A mesh defines the geometric structure of a 3D object by specifying the positions of its vertices in 3D space. These vertices are connected to form edges and faces, which define the shape of the object. Vertices are the individual points in 3D space that make up the mesh. Edges connect vertices, and faces are formed by connecting multiple vertices and edges to create flat surfaces (e.g., polygons, triangles or quadrilaterals). The combination of vertices, edges, and faces gives the mesh its shape.

In addition, a mesh can provide individual vertex control that offers a superior level of detail, enabling the portrayal of facial expressions that might prove challenging to achieve through blendshape blending alone. Also, mesh animation can allow developers a greater degree of creative freedom.

However, manually controlling mesh vertices poses greater technical complexity and demands more time from artists, especially when dealing with facial animations requiring intricate vertex-level precision. Additionally, compatibility with real-time rendering engines can be difficult, e.g., setting each vertex position individually for every frame can be slow and tedious in game engines (e.g., Unreal or Unity). Furthermore, mesh animation techniques can disable some smart functionality that are optimized for blendshapes.

According to an embodiment, a method and system is provided that can achieve realistic and expressive facial animation in interactive applications, such as video games. Further, the method can address limitations of existing techniques by leveraging a neural network to predict and generate facial movements with high fidelity and efficiency.

In addition, unlike other techniques that rely on predefined blendshapes or laborious manual manipulation of individual vertices, the method can employ a data-driven approach, in which a neural network is trained on a dataset of facial expressions, learning to capture the complex relationships between different facial features and movements, according to embodiments. This trained AI network model can then generate new animations in real-time, responding dynamically to various inputs such as audio speech, video or motion capture data.

For example, the method can predict vertex positions with high accuracy, capturing even subtle facial movements, while simultaneously generating blendshapes automatically. This can eliminate the need for tedious manual adjustments of individual vertices or the laborious creation of predefined blendshapes.

In addition, according to an embodiment, a method and system can be provided that provides a unique encoder-decoder architecture, in which the encoder processes input data (e.g., an audio stream of spoken dialogue), and extracts a compact representation of the intended facial expressions in the form of blendshape coefficients (e.g., a compressed representation). Then the blendshape coefficients can be passed to the decoder. The decoder can use the blendshape coefficients to reconstruct the full facial animation by applying them to a set of learned blendshapes.

Also, the encoder can be located on a server and the decoder can be located on a separate device with potentially less processing power. Alternatively, the decoder can be strategically positioned on dedicated hardware designed for graphic rendering, such as a GPU, while the encoder can be situated on a specific location within the same chip, optimized for neural computing.

In this way, this division of tasks can allow for efficient animation and transfer of data even on resource-constrained devices, as the computationally intensive task of analyzing the input data can offloaded to more powerful hardware.

For example, the method and system can allow for complex computations to be performed on the server or other dedicated hardware, while only blendshape coefficients are transmitted to the target device (e.g., user's end device), which can drastically reduce latency and ensure smooth, real-time performance even on less powerful hardware.

In more detail, according to an embodiment, a method and system can provide an end-to-end neural network architecture to directly optimize the location of vertices in avatar animation from an audio or video driven signal (e.g., an input audio recording). Once the training process is complete, the network can be partitioned into an encoder component and a decoder component. For example, the encoder can correspond to the entire neural network except for its last layer. The decoder can correspond to the network's final layer (e.g., a fully connected layer or linear layer).

In addition, the decoder can be deployed on a separate device, but embodiments are not limited thereto. For applications using a server-side and edge-side hybrid architecture, the decoder can be placed on the edge side, while the encoder can be located on the server side. Alternatively, this architecture is versatile and can accommodate scenarios where both the encoder and decoder reside on the same device.

For example, according to an embodiment, the decoder can be strategically positioned on dedicated hardware designed for graphic rendering, while the encoder can be situated on a specific location within the same chip, optimized for neural computing. In this way, each component can operate at peak efficiency while minimizing any data transfer overhead between the encoder and decoder, whether it occurs over the internet or through chip-level communication.

Accordingly, vertex-level animation can be improved by allowing it to be accessible to a wide range of applications with varying resource constraints, while maximizing performance and minimizing data transfer bottlenecks.

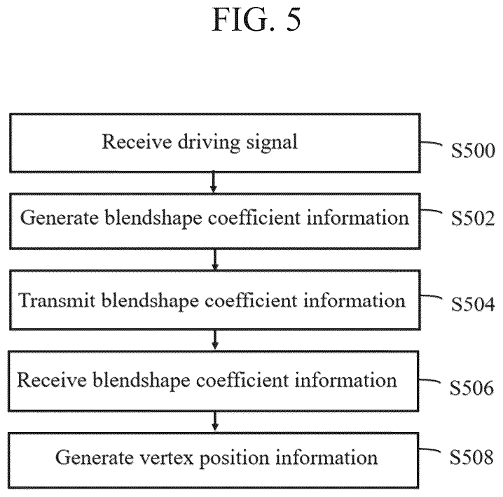

FIG. 5 shows an example flow chart of a method according to an embodiment. For example, a method for neural network driven vertex animation can include receiving, by an encoder component of a trained neural network, an input driving signal including audio data (e.g., S500), processing, by the encoder component, the input driving signal to generate blendshape coefficient information based on the input driving signal (e.g., S502), and transmitting, by the encoder component, the blendshape coefficient information to a decoder component of the trained neural network (e.g., S506)

Also, the method can further include receiving, by the decoder component, the blendshape coefficient information from the encoder component (e.g., S506), and generating, by the decoder component, vertex position information based on the blendshape coefficient information for animating a 3D model (e.g., S508). In addition, the method can include displaying the 3D model with aminated movements based on the vertex position information.

According to an embodiment, the blendshape coefficient information includes an F×B matrix of blendshape coefficients, where F corresponds to a number of animation frames corresponding to an audio length of the input driving signal, and B corresponds to a number of blendshapes, and the vertex position information includes an F′×V×3 tensor, where F′ corresponds to a number of animation frames for animating the 3D model, V corresponds to a number of vertices in the 3D model, and 3 corresponds to x, y, and z coordinates of the vertices, which is described in more detail below.

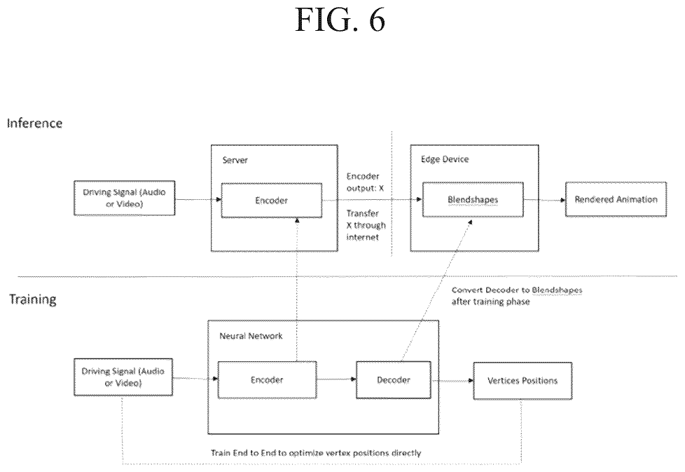

FIG. 6 shows network architecture during a training phase and an inference phase, according to embodiments of the present disclosure.

During a training phase, an AI model including a neural network can learn complex mappings between input driving signals and corresponding facial expressions. This training can involve presenting the AI model with paired data, including a driving signal and the desired vertex positions for each frame of the animation.

According to an embodiment, input data that is received by the AI model during training can include two components, such as a driving signal (e.g., audio or video) and ground truth information.

For example, the driving signal input to the encoder during training can be in the form of audio, video or other formats that provide information for driving the facial animation (e.g., a 3 second recording of audio or video). For instance, an audio stream of spoken dialogue or noises can be used to animate an avatar's lips and facial expressions in sync with the speech.

Further in this example, ground truth vertex positions can be input to the encoder during training, which can be a tensor of dimensions F×V×3, where F represents the number of frames in the animation, V represents the number of vertices in the facial mesh, and 3 represents the x, y, and z coordinates of each vertex. This tensor can provide the target vertex positions for each frame, corresponding to the provided driving signal.

According to an embodiment, the AI model can adopt an encoder-decoder architecture. The encoder can process the input driving signal and extract a compact representation of the desired facial expressions. This compact representation can then be passed to the decoder, which reconstructs the full facial animation in the form of vertex positions.

The encoder can be implemented using various neural network architectures, such as Convolutional Neural Networks (CNNs) for processing spatial data like images, Recurrent Neural Networks (RNNs) for processing sequential data like audio, or transformers for capturing long-range dependencies in the input data, or combinations thereof. According to an embodiment, the decoder can include a fully connected layer, with or without bias, which maps the encoder's output to the vertex positions.

Further in this example, during training, the encoder can output an F×B matrix, where B is the number of blendshapes learned by the neural network. Each row or column of this matrix can include the blendshape weights for a specific frame, determining the contribution of each blendshape to the final facial expression. For example, the output of the encoder can include a set of weights associated with each blendshape for each frame of animation (e.g., 64 weights, one weight for each blendshape).

In addition, the decoder can receive the F×B matrix output by the encoder, and, through a weighted sum with the B blendshapes, generate an F×V×3 tensor containing the predicted positions of all vertices in the facial mesh for each frame of the animation.

In order to train the AI model including the neural network, a loss function can be used, such as Mean Squared Error (MSE), to measure the difference between the predicted vertex positions (e.g., predicted F×V×3 tensor) and the ground truth vertex positions (e.g., ground truth F×V×3 tensor). This loss value or difference between the two tensors can guide the optimization process.

Further, optimization during training of the AI model can include a backpropagation algorithm to update the weights and biases of the neural network, as well as the learned blendshapes, in a direction that minimizes the loss function. This iterative process can repeatedly continue until the network achieves a satisfactory level of accuracy in predicting vertex positions from the input driving signal or until a certain convergence is reached, in order to generate the trained AI model.

Also, since the blendshapes are learned by the AI model, they make look vastly different than the type of blendshapes that would be created by a human animated, e.g., blendshapes could correspond to transition states or mixed emotions that may look very different than blendshapes that corresponding to common facial expressions, such as those in FIG. 4, part (a).

According to embodiment, the trained AI model can be stored in a memory of the AI device 100 or transmitted to an external device, or different portions of the trained AI model can be stored on separate devices.

As explained in more detail below, according to a preferred embodiment, the trained encoder can be stored in an external device (e.g., a server) and the trained decoder can be stored in the AI device 100, but embodiments are not limited thereto. For example, according to another embodiment, the trained encoder and the trained decoder can be located on different parts of a same chip or on different hardware components within the same AI device 100.

With reference again to FIG. 6, during an inference phase, the trained AI model can be used to receive an input driving signal (e.g., audio or video) to automatically generate rendered animation based on learned blendshapes.

As discussed above, during inference, the neural network architecture can include an encoder and a decoder. The encoder can receive the input driving signal and output blendshape coefficients that are transmitted to the decoder.

The decoder, which can be in the form of a fully connected layer or linear layer, can generate a set of blendshapes. The blendshapes can be used for efficient representation and compatibility with various game engines (e.g., Unreal or Unity, etc.). The linear layer can be used to reconstruct the vertex positions using the blendshape coefficients generated by the encoder.

According to an embodiment, the linear layer can be represented as WX+b, where W is the weight matrix, b is the bias vector (e.g., base mesh), and X is the output from the encoder. The weight matrix W has dimensions m×n×3 (where m is the dimensionality of the encoder's output, n is the number of vertices, and 3 represents the x, y, and z coordinates). Also, m can be smaller than n.

For example, for the decoder to generate an output of n vertices, where each vertex has 3 dimensions (x, y, and z), the weight matrix W has dimensions of m by n by 3. Here, m represents the dimensionality of the encoder's output, which can be significantly smaller than n.

Upon matrix multiplication of the weight matrix W in the decoder with the encoder's output X (e.g., an m-dimensional embedding vector), the result WX effectively reconstructs the n vertices in 3D space.

Also, the bias vector b can be added to the result of the matrix multiplication and provides an offset for each vertex. The bias vector b can have dimensions of 1 by n by 3, which can ensure that each of the n vertices receives a unique 3-dimensional bias.

In addition, the weight matrix W in the decoder can be transformed as a set of blendshapes. For example, the weight matrix W, which has dimensions m×n×3, can be transformed into m distinct blendshapes. Each of these blendshapes can contain n vertices, and each vertex can be described by its 3-dimensional coordinates (e.g., x, y, z).

For purposes of explanation of this transformation, the weight matrix W can be broken down into m individual matrices, denoted as W_i, where each W_i has dimensions n×3. Each W_i corresponds to a single blendshape, defining the positions of all n vertices for that specific expression.

For example, the output of the decoder can be transformed into a format that is suitable for use in game engines and other 3D animation software. The transformation process can treat each W_i matrix, derived from the weight matrix W, as a distinct blendshape. These blendshapes can represent complete target expressions, not just offsets from a neutral pose. To achieve this, the bias vector b can be added to each W_i, resulting in the final blendshape W_i+b.

In this way, the blendshapes can be seamlessly integrated into different types of game engines. For example, the neutral expression of the 3D model can be represented by the bias vector b, and each blendshape can define a specific deviation from this neutral state.

In other words, this process can convert the learned weights of the decoder into a format readily usable by various game engines and other 3D animation software which can allow the output of the trained AI model to be more practical and efficient.

For example, by transforming the decoder's output into blendshapes, the animation data can be efficiently stored and processed, and it can be compatible with a wider range of animation tools and platforms, including those used on edge devices.

Also, according to an embodiment, while the neural network can be trained using full 32-bit precision floating-point values for the weight matrix W, this precision can be reduced to 16-bit or other quantized formats when storing the data in a blendshape file (e.g., .fbx). This reduction in precision can minimize storage requirements without significantly compromising the accuracy of the facial animation. This optimization can contribute to the overall efficiency, making it even more suitable for deployment on devices with limited storage capacity.

In addition, the compatibility of the generated blendshape file with standard game engines and 3D modeling software can offer further advantages. For example, developers can manually edit and refine the blendshapes generated by the decoder using off-the-shelf tools, which can provide further performance optimization by creating multiple levels of detail (LODs) for the blendshapes, enabling efficient rendering based on the distance and importance of the animated character in the scene, and enhanced visual fidelity by adding subtle details and nuances to the facial expressions, such as wrinkles or skin folds, to enhance realism.

For example, this capability for further editing and refinement can provide flexibility and artistic control over the final animation, allowing for customization and additional fine-tuning.

In more detail, the inference process utilizes the trained neural network to generate facial animation in real-time from an input audio signal or input video signal. This process can include an input step, an encoder step, a data transfer step, and a blendshape application step.

For example, the input to the trained neural network can be an audio signal of length T seconds, representing speech, sounds, or any audio that drives the desired facial expressions.

Further in this example, the encoder can process the input audio and produce an F×B matrix containing blendshape weights for each frame of the animation. F can represent the number of animation frames, which can be determined based on the audio length T seconds and the desired frames per second (fps). For example, if the input audio is T seconds long and the target frame rate is 30 fps, then the number of animation frames F=T×30. Also, B can represent the number of blendshapes learned by the neural network during training.

In addition, during the data transfer step, the F×B matrix generated by the encoder can be transmitted over a network to the target device where the animation will be rendered using the decoder. This matrix transmitted by the encoder can be significantly smaller than transmitting the full set of vertex positions (F×V×3) for each frame, resulting in reduced latency and bandwidth consumption.

Further still in this example, in the blendshape application step, the B blendshape coefficients for each frame can used by the target device (e.g., an edge device including the decoder) to compute a weighted sum of the blendshapes. Each blendshape can be a matrix of 3D vertex positions (V×3), and the resulting weighted sum, also with dimensions V×3, can provide the final vertex positions for that frame. Accordingly to embodiments, this blendshape application can be performed either within a game engine, leveraging its optimized rendering pipeline, or using the decoder portion of the neural network.

In addition, according to an embodiment, the number of vertices (V) in the blendshapes used on the target device can be different than the number of vertices used during training. This flexibility can allow for adapting the animation to different levels of detail or for refining the blendshapes after training to enhance visual fidelity or optimize performance.

To illustrate an example of the efficiency gains of the method according to an embodiment, consider a scenario where a game engine utilizes 64 high-resolution blendshape meshes, each comprised of 50,000 vertices, and the animation is generated for a 10-second audio clip at 30 frames per second, and all scalars are 32-bit floating-point numbers.

As comparative example that does not use the method, transmitting the complete vertex positions for each frame to an edge device would require sending 300 frames×50,000 vertices×3 coordinates×32 bits per coordinate, which translates to about 171.7 megabytes.

In contrast to the comparative example, according to an embodiment, the AI device 100 configured with the method can transmit only the blendshapes weight coefficients from the encoder to the decoder, resulting in a significantly smaller data size. In this example, the data transfer would be 300 frames×64 blendshapes weights for a total of about 75 kilobytes.

This substantial reduction in data size, from 171.7 megabytes to 75 kilobytes highlights the efficiency of the method, especially in scenarios where bandwidth is limited or latency is critical. By transmitting only the essential blendshape coefficients instead of the full vertex data, the method can enable smoother and more responsive facial animation, particularly on resource-constrained devices. Also, 64 blendshapes is merely used as an example, and different numbers of blendshapes can be used (e.g., 128 blendshapes).

According to an embodiment, the AI device 100 can be configured to use animated facial expressions based on a neural network by predicting vertex positions and generating blendshapes. The AI device 100 can be used in various types of different situations.

According to one or more embodiments of the present disclosure, the AI device 100 can solve one or more technological problems in the existing technology, such as providing class-specific data augmentation policies for increasing the diversity of training data and a more accurate AI model that can provide object classification related tasks and/or face recognition. For example, the AI device can address to need of being able to automatically generate more useful training data that can be used to produce more accurate AI models.

Also, according to an embodiment, the AI device 100 configured with the trained AI model can be used in a mobile terminal, a smart TV, a home appliance, a robot, an infotainment system in a vehicle, etc.

Further, according to an embodiment, the AI device 100 including the trained AI model can implement an encoder-decoder architecture to predict vertex positions and generate blendshape coefficients that can be transmitted to a target device where they are applied to a set of blendshapes to reconstruct the full animation, enabling efficient and realistic animation having in interactive applications, while also minimizing data transfer.

For example, the AI device can be applied in a wide range of interactive applications including a digital avatar or computer animation.

In addition, the method can use a neural network to animate facial expressions by predicting vertex positions and generating blendshapes while improving latency and compatibility.

Further, the method can provide automatically generated animations by predicting vertex positions and generating blendshapes while improving latency and compatibility, minimizing data transfer, and can be seamlessly integrating with existing platforms.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for a neural network driven vertex animation, the method comprising:
receiving, by an encoder component of a trained neural network, an input driving signal including audio data;
processing, by the encoder component, the input driving signal to generate blendshape coefficient information based on the input driving signal;
transmitting, by the encoder component, the blendshape coefficient information to a decoder component of the trained neural network;
receiving, by the decoder component, the blendshape coefficient information from the encoder component; and
generating, by the decoder component, vertex position information based on the blendshape coefficient information for animating a three-dimensional (3D) model.

2. The method of claim 1, further comprising:
displaying the 3D model with aminated movements based on the vertex position information.

3. The method of claim 1, wherein the blendshape coefficient information includes an F x B matrix of blendshape coefficients, where F corresponds to a number of animation frames corresponding to an audio length of the input driving signal, and B corresponds to a number of blendshapes, and
wherein the vertex position information includes an F′×V×3 tensor, where F′ corresponds to a number of animation frames for animating the 3D model, V corresponds to a number of vertices in the 3D model, and 3 corresponds to x, y, and z coordinates of the vertices.

4. The method of claim 1, wherein the encoder component is located on a server, and
wherein the decoder component is located on an edge device that is separate from the server.

5. The method of claim 1, wherein the decoder component includes a fully connected layer.

6. The method of claim 5, wherein the fully connected layer is represented as WX+b, where W is a weight matrix, b is a bias vector or a base mesh, and X is the blendshape coefficient information output from the encoder component.

7. The method of claim 5, further comprising:
transforming information based on the decoder component into a set of blendshapes based on converting the weight matrix into distinct blendshapes, wherein each blendshape in the set of blendshapes includes a matrix corresponding to a single blendshape defining positions of vertices for a specific expression or animation.

8. The method of claim 1, further comprising:
generating the trained neural network by inputting pairs of input data and ground-truth tensors including vertex position information to a neural network, outputting predicted tensors by the neural network, and optimizing the neural network to minimize a loss function based on a difference between the predicted tensors and ground-truth tensors for producing the trained neural network.

9. A method for controlling an artificial intelligence (AI) device, the method comprising:
receiving an input driving signal including audio data;
processing the input driving signal by an encoder component of a trained neural network to generate blendshape coefficient information based on the input driving signal; and
transmitting the blendshape coefficient information over a network to a target device for animating a three-dimensional (3D) model.

10. The method of claim 9, wherein the blendshape coefficient information includes an F×B matrix of blendshape coefficients, where F corresponds to a number of animation frames corresponding to an audio length of the input driving signal, and B corresponds to a number of blendshapes, and
wherein the vertex position information includes an F′×V×3 tensor, where F′ corresponds to a number of animation frames for animating the 3D model, V corresponds to a number of vertices in the 3D model, and 3 corresponds to x, y, and z coordinates of the vertices.

11. An artificial intelligence (AI) system, comprising:
an encoder component of a trained neural network, the encoder component configured to:
receive an input driving signal including audio data,
process the input driving signal to generate blendshape coefficient information based on the input driving signal, and
transmit the blendshape coefficient information; and
a decoder component of the trained neural network, the decoder component configured to:
receive the blendshape coefficient information from the encoder component, and
generate vertex position information based on the blendshape coefficient information for animating a three-dimensional (3D) model.

12. The AI system of claim 11, further comprising:
a display configured to display the 3D model with aminated movements based on the vertex position information.

13. The AI system of claim 11, wherein the blendshape coefficient information includes an F×B matrix of blendshape coefficients, where F corresponds to a number of animation frames corresponding to an audio length of the input driving signal, and B corresponds to a number of blendshapes, and
wherein the vertex position information includes an F′×V×3 tensor, where F′ corresponds to a number of animation frames for animating the 3D model, V corresponds to a number of vertices in the 3D model, and 3 corresponds to x, y, and z coordinates of the vertices.

14. The AI system of claim 11, wherein the encoder component is located on a server, and
wherein the decoder component is located on an edge device that is separate from the server.

15. The AI system of claim 11, wherein the decoder component includes a fully connected layer.

16. The AI system of claim 15, wherein the fully connected layer is represented as WX+b, where W is a weight matrix, b is a bias vector or a base mesh, and X is the blendshape coefficient information output from the encoder component.

17. The AI system of claim 11, wherein the trained neural network is generated based on inputting pairs of input data and ground-truth tensors including vertex position information to a neural network, outputting predicted tensors by the neural network, and optimizing the neural network to minimize a loss function based on a difference between the predicted tensors and ground-truth tensors for producing the trained neural network.

18. An artificial intelligence (AI) device, comprising:
a display configured to display an image;
a memory configured to store three-dimensional (3D) model information; and
a controller configured to:
receive blendshape coefficient information from an external device,
generate vertex position information based on a trained neural network for animating a 3D model, and
display the 3D model with aminated movements based on the vertex position information.

19. The AI device of claim 18, wherein the blendshape coefficient information includes an F×B matrix of blendshape coefficients, where F corresponds to a number of animation frames corresponding to an audio length of the input driving signal, and B corresponds to a number of blendshapes, and
wherein the vertex position information includes an F′×V×3 tensor, where F′ corresponds to a number of animation frames for animating the 3D model, V corresponds to a number of vertices in the 3D model, and 3 corresponds to x, y, and z coordinates of the vertices.

20. The AI device of claim 18, wherein the trained neural network includes a fully connected layer. and
wherein the fully connected layer is represented as WX+b. where W is a weight matrix. b is a bias vector or a base mesh, and X is the blendshape coefficient information output from the external device.
